(19) United States
(12) Patent Application Publication
(10) Pub. No.: US 2021/0097410 A1
(43) Pub. Date: Apr. 1, 2021

(54) RECOMMODATION METHOD, RECOMMODATION APPARATUS, ELECTRONIC DEVICE AND STORAGE MEDIUM

(71) Applicant: Baidu Online Network Technology (Beijing) Co., Ltd., Beijing (CN)

(72) Inventors: Feng Liu, Beijing (CN); Zhongji Fan, Beijing (CN); Xinwei Lv, Beijing (CN); Bingbing Zhang, Beijing (CN); Xiaoyang Gao, Beijing (CN)

(21) Appl. No.: 16/788,778

(22) Filed: Feb. 12, 2020

(30) Foreign Application Priority Data
Sep. 29, 2019 (CN) 201910935875.3

(51) Int. Cl. G06N 5/04; G06N 20/00

(52) U.S. Cl. CPC G06N 5/04; G06Q 30/0631; G06N 20/00

(57) ABSTRACT

A recommendation method, a recommendation apparatus, an electronic device and a storage medium are provided, which relate to the field of computer technology. Specific implementation solution is the following: determining a current round of requirement and contextual information, according to session information; determining a plurality of recommendation items according to the current round of requirement and the contextual information; for each recommendation item of the recommendation items, determining a predicted click-through rate of the recommendation item according to the contextual information and a feature of the recommendation item; and determining at least one final recommendation item from the plurality of recommendation items, according to predicted click-through rates of the recommendation items. This application improves the analysis accuracy of the user's requirement, thereby improving the recommendation quality.

### CROSS-REFERENCE TO RELATED APPLICATION

This application claims priority to Chinese Patent Application No. 201910935875.3, filed on Sep. 29, 2019, which is hereby incorporated by reference in its entirety.

### TECHNICAL FIELD

The present application relates to the field of computer technology, and in particular, to the field of information retrieval technology.

### BACKGROUND

In existing information recommendation systems, a recommendation is mainly based on a user's single round of information. Without any analysis on the user's requirement in the current situation, it is often difficult to find the user's real interest point, and the recommendation quality is low, which brings a poor user experience.

### SUMMARY

A recommendation method, a recommendation apparatus, an electronic device and a storage medium are provided according to embodiments of the present application, so as to at least solve the technical problems above in the existing technology.

In a first aspect, a recommendation method is provided according to an embodiment of the present application, which includes:

determining a current round of requirement and contextual information, according to session information;

determining a plurality of recommendation items according to the current round of requirement and the contextual information;

for each recommendation item of the recommendation items, determining a predicted click-through rate of the recommendation item according to the contextual information and a feature of the recommendation item; and

determining at least one final recommendation item from the plurality of recommendation items, according to predicted click-through rates of the recommendation items.

In the above embodiment, the session information is fully excavated, a recommendation item is determined based on the current round of requirement and in connection with the contextual information and features of the recommendation items, thereby the analysis accuracy of the user's requirement is improved, and the recommendation quality and user experience is further improved.

In an embodiment, the determining a plurality of recommendation items according to the current round of requirement and the contextual information, includes:

extracting a user intention and a keyword from the current round of requirement and the contextual information; and

retrieving the plurality of recommendation items from search data, according to the user intention and the keyword.

In an embodiment, the recommendation method further includes: performing a preliminary filtering process on the plurality of recommendation items, to acquire a plurality of recommendation items after the preliminary filtering process, wherein

the preliminary filtering process includes at least one of:

determining historical access data of the recommendation items and relevancies between the recommendation items and the keyword, and filtering out a recommendation item whose historical access data and relevancy do not satisfy a preset condition; and

filtering out a repetitive recommendation item from the plurality of recommendation items.

In the above embodiment, the recommendation items are filtered according to the historical access data of the recommendation items and the relevancies between the recommendation items and the keyword. Taking into account the popularity and relevancy of a recommendation item, it is beneficial to improve the quality of the recommendation item. The process filters out a repetitive recommendation item, which may avoid recommending a repetitive content to the user, and improve the quality of recommendation.

In an embodiment, the determining a predicted click-through rate of the recommendation item according to the contextual information and the feature of the recommendation item, includes:

extracting a contextual feature from the contextual information; and

inputting the contextual feature and the feature of the recommendation item into a pre-trained click-through rate prediction model, and outputting the predicted click-through rate of the recommendation item by the click-through rate prediction model.

In the above embodiment, a click-through rate of the recommendation item is predicted by the click-through rate prediction model, which may better find the relationship between the contextual feature and the feature of the recommendation item and the predicted click-through rate, and improve the accuracy of the click-through rate prediction.

In an embodiment, the recommendation method further includes:

acquiring user feedback behavior data of a historical recommendation item; and

determining a recommendation strategy of the final recommendation item, according to the user feedback behavior data.

In the above embodiment, taking into account the user's historical feedback, a final content that needs to be recommended is presented to the user in an appropriate way, which may improve the rationality of recommendation, reduce the interference to the user, and improve the user experience.

In an embodiment, the contextual information includes: at least one of user inquiry information, system prompt information and user interest information.

In a second aspect, a method for training a click-through rate prediction model is provided according to an embodiment of the present application, which includes:

determining a current round of requirement and contextual information, according to session information;

determining a plurality of recommendation items according to the current round of requirement and the contextual information; and

acquiring actual click-through rates of the recommendation items, and training the click-through rate prediction model by taking the contextual information, features of the recommendation items and the actual click-through rates of the recommendation items as training samples.

In an embodiment, a feature of each recommendation item of the recommendation items includes at least one of a matching degree between the recommendation item and the current round of requirement, an edit distance between the recommendation item and the current round of requirement, a consistency between the recommendation item and an intention of the current round of requirement, and a presentation position of the recommendation item.

In a third aspect, a recommendation apparatus is provided according to an embodiment of the present application, which includes:

a session information module, configured to determine a current round of requirement and contextual information, according to session information;

a recommendation item determination module, configured to determine a plurality of recommendation items according to the current round of requirement and the contextual information;

a predicted click-through rate determination module, configured to, for each recommendation item of the recommendation items, determine a predicted click-through rate of the recommendation item according to the contextual information and a feature of the recommendation item; and

a final recommendation item determination module, configured to determine at least one final recommendation item from the plurality of recommendation items, according to predicted click-through rates of the recommendation items.

In an embodiment, the recommendation apparatus further includes:

a preliminary filtering module, configured to perform a preliminary filtering process on the plurality of recommendation items, to acquire a plurality of recommendation items after the preliminary filtering process, wherein

the preliminary filtering module includes at least one of:

a first filtering sub-module, configured to determine historical access data of the recommendation items and relevancies between the recommendation items and the keyword, and filter out a recommendation item whose historical access data and relevancy do not satisfy a preset condition; and

a second filtering sub-module, configured to filter out a repetitive recommendation item from the plurality of recommendation items.

In an embodiment, the predicted click-through rate determination module includes:

a contextual feature extraction sub-module, configured to extract a contextual feature from the contextual information; and

a prediction sub-module, configured to input the contextual feature and the feature of the recommendation item into a pre-trained click-through rate prediction model, and output the predicted click-through rate of the recommendation item by the click-through rate prediction model.

In an embodiment, the recommendation apparatus further includes:

a feedback acquiring module, configured to acquire user feedback behavior data of a historical recommendation item; and

a recommendation strategy determination module, configured to determine a recommendation strategy of the final recommendation item according to the user feedback behavior data.

In a fourth aspect, an apparatus for training a click-through rate prediction model is provided according to an embodiment of the present application, which includes:

a session information analysis module, configured to determine a current round of requirement and contextual information, according to session information;

a recommendation item determination module, configured to determine a plurality of recommendation items according to the current round of requirement and the contextual information; and

a training module, configured to acquire actual click-through rates of the recommendation items, and train the click-through rate prediction model by taking the contextual information, features of the recommendation items and the actual click-through rates of the recommendation items as training samples.

In a fifth aspect, an electronic device is provided according to an embodiment of the present application, the functions of the electronic device may be implemented by hardware or by executing corresponding software with hardware. The hardware or software includes one or more modules corresponding to the functions described above.

In a possible design, the electronic device includes a processor and a storage. The storage is configured to store a program, which causes the electronic device to implement the above recommendation method; and the processor is configured to execute the program stored in the storage. The electronic device further includes a communication interface configured for communication between the electronic device and another apparatus or communication network.

In a sixth aspect, a computer readable storage medium is provided according to an embodiment of the present application, which stores computer software instructions for use by the recommendation apparatus. The computer software instructions include a program involved in execution of the above recommendation method.

Other effects of the above alternatives will be described below with reference to specific embodiments.

### BRIEF DESCRIPTION OF THE DRAWINGS

The drawings are used to better understand the embodiments, and do not constitute limitations to the application, wherein:

FIG. 1 is a first flowchart of a recommendation method according to an embodiment of the present application;

FIG. 2 is a flowchart of S102 in the recommendation method according to an embodiment of the present application;

FIG. 3 is a second flowchart of the recommendation method according to an embodiment of the present application;

FIG. 4 is a flowchart of S103 in the recommendation method according to an embodiment of the present application;

FIG. 5 is a flowchart of a method for training a click-through rate prediction model according to an embodiment of the present application;

FIG. 6 is a first structural block diagram of a recommendation apparatus according to an embodiment of the present application;

FIG. 7 is a second structural block diagram of the recommendation apparatus according to an embodiment of the present application;

FIG. 8 is a structural block diagram of a predicted click-through rate determination module 603 in the recommendation apparatus according to an embodiment of the present application;

FIG. 9 is a structural block diagram of an apparatus for training a click-through rate prediction model 900 according to an embodiment of the present application; and

FIG. 10 is a block diagram of an electronic device for implementing the recommendation method according to an embodiment of the present application.

### DETAILED DESCRIPTION OF THE EMBODIMENTS

Exemplary embodiments of the present application are described below with reference to the accompanying drawings, which include various details of embodiments of the present application to facilitate understanding, and they should be considered as merely exemplary. Therefore, those skilled in the art should recognize that various changes and modifications can be made to the embodiments described herein without departing from the scope and spirit of the application. Also, for clarity and conciseness, descriptions of well-known functions and structures are omitted below.

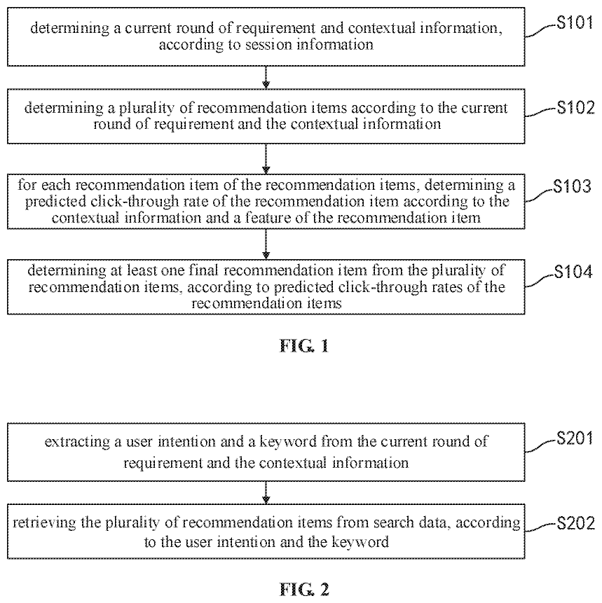

FIG. 1 is a flowchart of a recommendation method according to an embodiment of the present application. As shown in FIG. 1, the recommendation method includes:

S101, determining a current round of requirement and contextual information, according to session information;

S102 determining a plurality of recommendation items according to the current round of requirement and the contextual information;

S103, for each recommendation item of the recommendation items, determining a predicted click-through rate of the recommendation item according to the contextual information and a feature of the recommendation item; and

S104, determining at least one final recommendation item from the plurality of recommendation items, according to predicted click-through rates of the recommendation items.

In the above embodiment, the session information is fully excavated, a recommendation item is determined based on the current round of requirement and in connection with the contextual information and features of the recommendation items. Specifically, a plurality of recommendation items are determined according to the current round of requirement and the contextual information, predicted click-through rates of the recommendation items are determined according to the contextual information and features of the recommendation items, and a recommendation item is determined based on the predicted click-through rates, thereby the analysis accuracy of the user's requirement is improved, and the recommendation quality is further improved.

It should be noted that the current round of requirement may be a user's requirement in a current round of conversation. The current round of conversation can be a latest round of conversion. Since there may be some invalid conversations sometimes, the current round of conversation may be adjusted as the latest N rounds of conversations, such as N=2, or N=3.

In an embodiment, the session information may include multiple rounds of communication information between a user and a system. In each round of communication between the user and the system, the system can receive the user's input information, process the user's input information, and then feedback according to the processed users input information. The user's input information may include a voice, text, touch selection or image. The system integrates a series of artificial intelligence technologies, including speech recognition, natural language processing, user portrait, image processing, etc.

In an embodiment, the recommendation method according to the embodiment can be applied to intelligent devices, such as a smart speaker, mobile phone, TV, tablet, intelligent robot, vehicle system, intelligent home and wearable device, etc.

In an embodiment, the recommendation items may be various information, TV resources, movie resources, audio resources, and web resources, etc.

In an embodiment, the contextual information includes: at least one of user inquiry information, system prompt information and user interest information.

In an embodiment, as shown in FIG. 2. S102 includes:

S201, extracting a user intention and a keyword from the current round of requirement and the contextual information; and

S202, retrieving the plurality of recommendation items from search data, according to the user intention and the keyword.

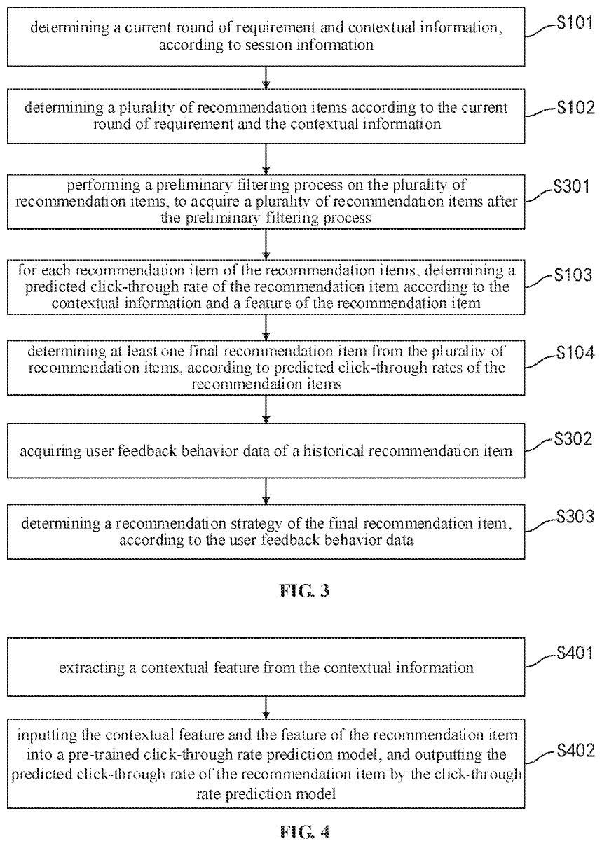

In an embodiment, as shown in FIG. 3, before S103, the recommendation method according to the embodiment may tither include:

S301, performing a preliminary filtering process on the plurality of recommendation items, to acquire a plurality of recommendation items after the preliminary filtering process.

In an embodiment, the preliminary filtering process in S301 includes at least one of a first type of filtering processing and a second type of filtering processing.

In a first type of filtering processing, historical access data of each recommendation item and a relevancy between each recommendation item and the keyword are determined, and a recommendation item whose historical access data and relevancy do not satisfy a preset condition is filtered out.

The historical access data of the recommendation item includes a PageView (PV) and a Unique Visitor (UV) of the recommendation item. PV indicates an accumulated access amount for the recommendation item, wherein a user's access to the respective recommendation item is recorded every time, and the access for the same recommendation item multiple times is accumulated. UV indicates the number of users accessing the recommendation item. For example, the same user's access to the recommendation item is counted only once on the same day.

In an example, filtering out a recommendation item whose historical access data and relevancy do not satisfy a preset condition includes: calculating scores of the recommendation items according to the historical access data and relevancies of the recommendation items; and filtering out a recommendation item whose score is lower than a preset score.

In another embodiment, filtering out a recommendation item whose historical access data and relevancy do not satisfy a preset condition includes: filtering out a recommendation item whose historical access data is lower than a preset historical access amount threshold and whose relevancy is lower than a preset relevancy threshold.

In the first type of filtering processing above, filtering is based on historical access data and relevancies. Taking into account the popularity and relevancy of a recommendation item, it is beneficial to improve the quality of the recommendation item.

In a second type of filtering processing, a repetitive recommendation item is filtered out from the plurality of recommendation items.

The second type of filtering processing may include filtering out a repetitive recommendation item, which may avoid recommending a repetitive content to the user, and improve the quality of recommendation.

In an embodiment, as shown in FIG. 4, S103 includes:

S401, extracting a contextual feature from the contextual information; and

S402, inputting the contextual feature and the feature of the recommendation item into a pre-trained click-through rate prediction model, and outputting the predicted click-through rate of the recommendation item by the click-through rate prediction model.

The click-through rate prediction model has the ability of autonomous learning and a high error-tolerant rate, can fully approximate complex non-linear relationships, and is highly adaptive. Therefore, in the above embodiment, a click-through rate of the recommendation item is predicted by the click-through rate prediction model, which may better find the relationship between the contextual feature and the feature of the recommendation item and the predicted click-through rate, and improve the accuracy of the click-through rate prediction.

In an embodiment, a pre-training process of the click-through rate prediction model includes: training the click-through rate prediction model by taking the contextual feature, features of the recommendation items and the actual click-through rates of the recommendation items as training samples.

In an embodiment, a feature of each recommendation item of the recommendation items includes at least one of a matching degree between the recommendation item and the current round of requirement, an edit distance between the recommendation item and the current round of requirement, a consistency between the recommendation item and an intention of the current round of requirement, and a presentation position of the recommendation item.

In the above embodiment, information such as a correlation between the recommendation item and the current round of requirement, and a presentation position of the recommendation item is taken as the feature of the recommendation item, to predict the click-through rate of the recommendation item, thereby improving the accuracy of the prediction result.

In an embodiment, during the training of the click-through rate prediction model, a logistic regression (LR) model may be used to train data, and an Area Under Curve (AUC) may be used to evaluate the effect of the model.

The logistic regression (LR) model is a generalized linear regression analysis model. The model has a form of w′x+b, wherein w and b are parameters to be solved, w′x+b corresponds to a hidden state p through a logical function L, p=L (w′x+b), and then the value of a dependent variable is determined according to the sizes of p and 1-p.

AUC is defined as an area enclosed by a receiver operating characteristic curve (ROC) and a coordinate axis. Obviously, the value of this area cannot be greater than 1. Because the ROC curve is generally above a liney=x, the value of AUC ranges between 0.5 and 1. The closer the AUC is to 1.0, the higher the veracity of the detection method. When AUC equals to 0.5, the veracity is the lowest and has no application value. ROC is a curve drawn according to a series of different binary classification methods (a cutoff value or a decision threshold), taking a true positive rate (sensitivity) as an ordinate, and a false positive rate (1-specificity) as an abscissa.

In an embodiment, S104 includes: determining a ranking order of the plurality of recommendation items according to the predicted click-through rates of the recommendation items; determining at least one final recommendation item from the plurality recommendation items according to the ranking order of the plurality of recommendation items. In an example, a preset number of recommendations ranked in front may be selected as final recommendation items. For example, the recommendation items ranked first to fifth can be final recommendation items.

Furthermore, a recommendation order of the final recommendation items can also be determined according to the ranking order. For example, the final recommendation items are recommended in order according to the ranking order, so that a recommendation item with a high predicted click-through rate is more easily found by a user, the probability of the user clicking the recommendation item is increased, and the stickiness of a product to the user is improved.

In an embodiment, still referring to FIG. 3, the method further includes:

S302, acquiring user feedback behavior data of a historical recommendation item; and

S303, determining a recommendation strategy of the final recommendation item, according to the user feedback behavior data.

In an example, the user feedback behavior data may include record data on whether the user accepts the historical recommendation item, and user comment feedback data on the historical recommendation item. For example, in the case that the user clicks the historical recommendation item frequently, the recommendation strategy at this time is to recommend the final recommendation item.

In the above embodiment, taking into account the user's feedback behavior on the historical recommendation item, a final content that needs to be recommended is presented to the user in an appropriate way, which may improve the rationality of recommendation, reduce the interference to the user, and improve the user experience.

In an example, in S302, the user feedback behavior data of the historical recommendation item may be selected from data in a recent preset time. Further, a reference weight of the user feedback behavior data with a closer date may be set to be larger, and a reference weight of the user feedback behavior data with a farther date may be set smaller.

In another embodiment, in S303, a recommendation strategy of the final recommendation item may be determined, according to a correlation score of the user feedback behavior data and the final recommendation item. The correlation score of the final recommendation item may be determined according to the predicted click-through rate, and the relevancy of the recommendation item and the keyword.

For example, in the case that less of historical recommendation items is accepted by the user and the correlation score is low below a first correlation score threshold), the recommendation strategy may be not to recommend the final recommendation item. In another example, if less of the historical recommendation item is accepted by the user, but the correlation score is high (for example, above a second correlation score threshold), then the recommendation strategy may be to actively ask the user whether to recommend.

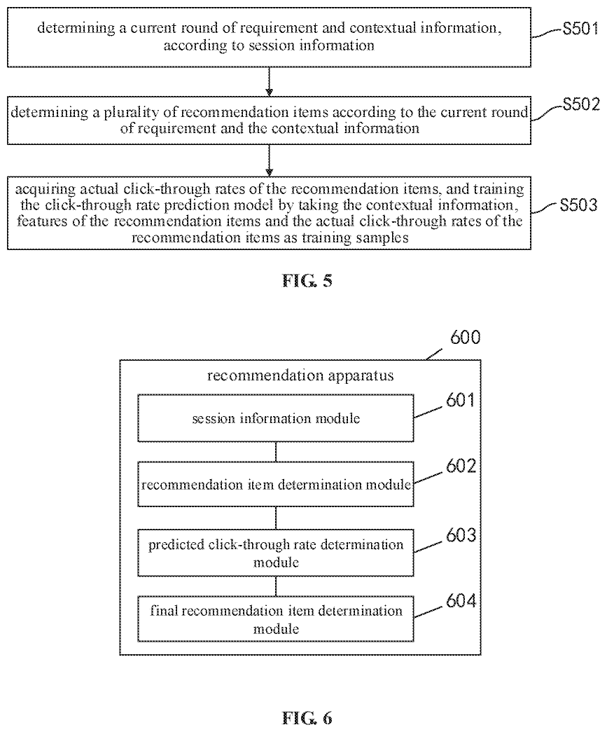

FIG. 5 is a flowchart of a method of training a click-through rate prediction model according to an embodiment of the present application. As shown in FIG. 5, the method includes:

S501, determining a current round of requirement and contextual information, according to session information;

S502, determining a plurality of recommendation items according to the current round of requirement and the contextual information; and

S503: acquiring actual click-through rates of the recommendation items, and training the click-through rate prediction model by taking the contextual information, features of the recommendation items and the actual click-through rates of the recommendation items as training samples.

In an embodiment, a feature of each recommendation item of the recommendation items includes at least one of a matching degree between the recommendation item and the current round of requirement, an edit distance between the recommendation item and the current round of requirement, a consistency between the recommendation item and an intention of the current round of requirement, and a presentation position of the recommendation item.

In an embodiment, during the training of a click-through rate prediction model, a logic regression (LR) model may be used to train data, and AUC may be used to evaluate the effect of the model.

The click-through rate prediction model trained in the above embodiment may predict a click-through rate of a recommendation item based on the contextual feature and a feature of the recommendation item, so as to provide a decisive suggestion for recommendation. For example, the higher the click-through rate is, the higher the possibility of recommending the recommendation item is. The session information is fully excavated, and the user requirement is analyzed effectively, thereby the quality of recommendation is improved.

FIG. 6 is a first structural block diagram of a recommendation apparatus according to an embodiment of the present application. As shown in FIG. 6, the recommendation apparatus 600 includes:

a session information module 601, configured to determine a current round of requirement and contextual information, according to session information.

a recommendation item determination module 602, configured to determine a plurality of recommendation items according to the current round of requirement and the contextual information.

a predicted click-through rate determination module 603, configured to, for each recommendation item of the recommendation items, determine a predicted click-through rate of the recommendation item according to the contextual information and a feature of the recommendation item; and

a final recommendation item determination module 604, configured to determine at least one final recommendation item from the plurality of recommendation items, according to predicted click-through rates of the recommendation items.

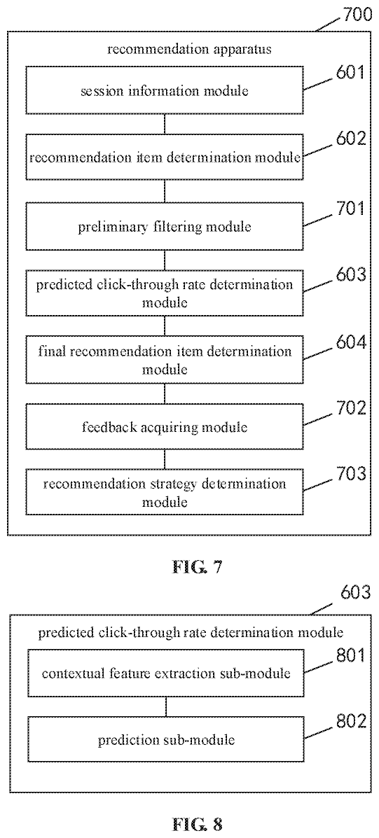

In another embodiment, as shown in FIG. 7, the recommendation apparatus 700 further includes: a preliminary filtering module 701, configured to perform a preliminary filtering process on the plurality of recommendation items, to acquire a plurality of recommendation items after the preliminary filtering process.

The preliminary filtering module 701 includes at least one of:

a first filtering sub-module, configured to determine historical access data of the recommendation items and relevancies between the recommendation items and the keyword, and filter out a recommendation item whose historical access data and relevancy do not satisfy a preset condition; and

a second filtering sub-module, configured to filter out a repetitive recommendation item from the plurality of recommendation items.

In an embodiment, as shown in FIG. 8, the predicted click-through rate determination module 603 includes:

a contextual feature extraction sub-module 801, configured to extract a contextual feature from the contextual information; and

a prediction sub-module 802, configured to input the contextual feature and the feature of the recommendation item into a pre-trained click-through rate prediction model, and output the predicted click-through rate of the recommendation item by the click-through rate prediction model.

In an embodiment, as shown in FIG. 7, the recommendation apparatus 700 further includes:

a feedback acquiring module 702, configured to acquire user feedback behavior data of a historical recommendation item; and

a recommendation strategy determination module 703, configured to determine a recommendation strategy of the final recommendation item, according to the user feedback behavior data.

The recommendation apparatus according to the embodiments of the present application fully excavates the session information, based on the current round of requirement and in connection with the contextual information and features of the recommendation items, thereby improving the analysis accuracy of the user's requirement, and further improving the recommendation quality and user experience.

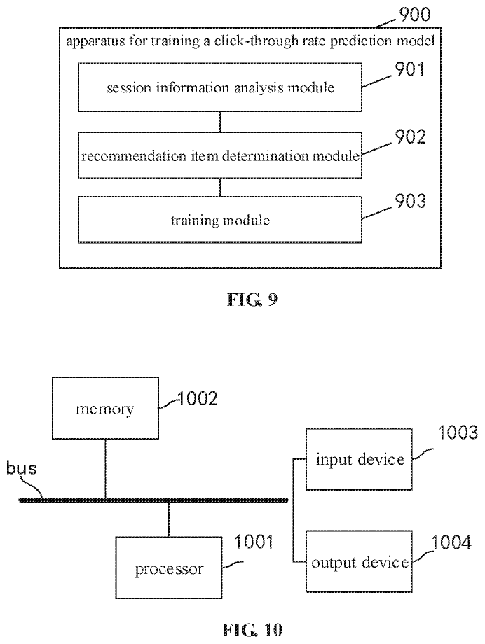

FIG. 9 is a structural block diagram of an apparatus 900 for training a click-through rate prediction model according to an embodiment of the present application. As shown in FIG. 9, the apparatus 900 includes:

a session information analysis module 901, configured to determine a current round of requirement and contextual information, according to session information;

a recommendation item determination module 902, configured to determine a plurality of recommendation items according to the current round of requirement and the contextual information; and

a training module 903, configured to acquire actual click-through rates of the recommendation items, and train the click-through rate prediction model by taking the contextual information, features of the recommendation items and the actual click-through rates of the recommendation items as training samples.

An electronic device and a readable storage medium are also provided according to embodiments of the present application.

As shown in FIG. 10, FIG. 10 is a block diagram of an electronic device for implementing the recommendation method according to an embodiment of the present application. Electronic devices are intended to represent various forms of digital computers, such as laptop computers, desktop computers, workbenches, personal digital assistants, servers, blade servers, mainframe computers, and other suitable computers. Electronic devices can also represent various forms of mobile devices, such as personal digital assistant, cellular phones, smart phones, wearable devices, and other similar computing devices. The components shown here, their connections and relationships, and their functions are merely examples, and are not intended to limit the implementation of the application described and/or required herein.

As shown in FIG. 10, the electronic device includes: one or more processors 1001, a memory 1002, and interfaces for connecting various components, including a high-speed interface and a low-speed interface. The various components are interconnected with different buses and can be mounted on a public mainboard or otherwise installed as required. The processor can process instructions executed within the electronic device, which include instructions stored in or on a memory to display graphic information of a graphical user interface (GUI) on an external input/output device (such as a display device coupled to the interface). In other embodiments, multiple processors and/or multiple buses can be used with multiple memories, if desired. Similarly, multiple electronic devices can be connected, each providing some of the necessary operations (for example, as a server array, a group of blade servers, or a multiprocessor system). A processor 1001 is taken as an example in FIG. 10.

The memory 1002 is a non-transitory computer readable storage medium according to an embodiment of the present application. The memory stores instructions executable by at least one processor, so that at least one processor executes the recommendation method according to the embodiments of the present application. The non-transitory computer readable storage medium of the present application stores computer instructions, which are used to cause a computer to implement the recommendation method according to the embodiments of this application.

As a non-transitory computer readable storage medium, the memory 1002 may be used to store non-transitory software programs, non-transitory computer executable programs, and modules, such as program instructions/modules corresponding to the recommendation method according to the embodiments of the present application (for example, the session information module 601, the recommendation item determination module 602, the predicted click-through rate determination module 603, and the final recommendation item determination module 604 as shown in FIG. 6). The processor 1001 executes various functional applications and data processing of the server by running non-transitory software programs, instructions, and modules stored in the memory 1002, that is, the recommendation method according to the embodiments of the present application can be implemented.

The memory 1002 may include a storage program area and a storage data area, where the storage program area can store an operating system and applications required for at least one function; the storage data area can store the data created according to the use of the electronic device for the recommendation method, etc. In addition, the memory 1002 can include a high-speed random access memory, and can also include a non-transitory memory, such as at least one magnetic disk storage device, a flash memory device, or other non-transitory storage devices. In some embodiments, the memory 1002 can alternatively include a memory remotely set relative to the processor 1001, and these remote memories can be connected to the electronic device for the recommendation method via a network. Examples of the network above include, but are not limited to, the Internet, an intranet, a local area network, a mobile communication network, and combinations thereof.

The electronic device for the recommendation method may further include an input device 1003 and an output device 1004. The processor 1001, the memory 1002, the input device 1003, and the output device 1004 can be connected through a bus or in other ways. In FIG. 10, the connection through the bus is taken as an example.

The input device 1003 can receive inputted numeric or character information, and generate key signal inputs related to user settings and function control of the electronic device for the recommendation method, such as a touch screen, a keypad, a mouse, a trackpad, a touchpad, a pointing stick, one or multiple mouse buttons, trackballs, joysticks and other input devices. The output device 1004 can include a display device, an auxiliary lighting device (for example, an LED), a haptic feedback device (for example, a vibration motor), and the like. The display device can include, but is not limited to, a liquid crystal display (LCD), a light emitting diode (LED) display, and a plasma display. In some embodiments, the display device can be a touch screen.

Various embodiments of the systems and technologies described herein can be implemented in digital electronic circuit systems, integrated circuit systems, application specific integrated circuits (ASICs), computer hardwares, firmwares, softwares, and/or combinations thereof. These various embodiments may include: implementation in one or more computer programs that are executable and/or interpretable on a programmable system including at least one programmable processor, which can be a dedicated or general-purpose programmable processor that can receive data and instructions from a storage system, at least one input device, and at least one output device, and transmit data and instructions to the storage system, at least one input device, and at least one output device.

These computing programs (also known as programs, software, software applications, or codes) include machine instructions of a programmable processor and may be implemented using high-level procedures and/or object-oriented programming languages, and/or assembly/machine languages. As used herein, the terms “machine readable medium” and “computer readable medium” refer to any computer program product, device, and/or device used to provide machine instructions and/or data to a programmable processor (for example, magnetic disks, optical disks, memories, and programmable logic devices (PLDs)), include machine readable media that receives machine instructions as machine-readable signals. The term “machine-readable signal” refers to any signal used to provide machine instructions and/or data to a programmable processor.

In order to provide interaction with the user, the systems and techniques described herein can be implemented on a computer that has a display device (for example, Cathode Ray Tube (CRT) or Liquid Crystal Display (LCD) monitor) for displaying information to the user; and a keyboard and pointing device (for example, a mouse or trackball) through which the user can provide input to the computer. Other kinds of devices can also be used to provide interaction with the user. For example, the feedback provided to the user can be any form of sensory feedback (for example, visual feedback, auditory feedback, or haptic feedback); and can be in any form (including acoustic input, voice input, or tactile input) to receive input from the user.

The systems and technologies described herein can be implemented in a computing system including background components (for example, as a data server), or a computing system including middleware components (for example, an application server), or a computing system including front-end components (for example, a user computer with a graphical user interface or a web browser, through which the user can interact with the implementation of the systems and technologies described herein), or a computing system including any combination of such background components, middleware components, and front-end components. The components of the system may be interconnected by any form or medium of digital data communication (for example, a communication network). Examples of communication networks include: a local area network (LAN), a wide area network (WAN), and the Internet.

The computer system may include clients and servers. The client and server are generally remote from each other and typically interact through a communication network. The client-server relationship is generated by computer programs running on the respective computers and having a client-server relationship with each other.

According to the technical solutions of the embodiments of the present application, the session information is fully excavated, a recommendation item is determined based on the current round of requirement and in connection with the contextual information and features of the recommendation items, thereby the analysis accuracy of the user's requirement is improved, and the recommendation quality and user experience is further improved.

It should be understood that the various forms of processes shown above can be used to reorder, add, or delete steps. For example, the steps described in this application can be executed in parallel, sequentially, or in different orders. As long as the desired results of the technical solutions disclosed in this application can be achieved, there is no limitation herein.

The specific embodiments above do not constitute a limitation on the protection scope of the present application. It should be understood by those skilled in the art that various modifications, combinations, sub-combinations and substitutions can be made according to design requirements and other factors. Any modification, equivalent replacement and improvement made within the spirit and principle of this application shall be included in the protection scope of this application.

What is claimed is:

1. A recommendation method, comprising:
determining a current round of requirement and contextual information, according to session information;
determining a plurality of recommendation items according to the current round of requirement and the contextual information;
for each recommendation item of the recommendation items, determining a predicted click-through rate of the recommendation item according to the contextual information and a feature of the recommendation item; and
determining at least one final recommendation item from the plurality of recommendation items, according to predicted click-through rates of the recommendation items.

2. The recommendation method according to claim 1, wherein the determining a plurality of recommendation items according to the current round of requirement and the contextual information, comprises:
extracting a user intention and a keyword from the current round of requirement and the contextual information; and
retrieving the plurality of recommendation items from search data, according to the user intention and the keyword.

3. The recommendation method according to claim 2, further comprising: performing a preliminary filtering process on the plurality of recommendation items, to acquire a plurality of recommendation items after the preliminary filtering process, wherein
the preliminary filtering process comprises at least one of:
determining historical access data of the recommendation items and relevancies between the recommendation items and the keyword, and filtering out a recommendation item whose historical access data and relevancy do not satisfy a preset condition; and
filtering out a repetitive recommendation item from the plurality of recommendation items.

4. The recommendation method according to claim 1, wherein the determining a predicted click-through rate of the recommendation item according to the contextual information and the feature of the recommendation item, comprises:
extracting a contextual feature from the contextual information; and
inputting the contextual feature and the feature of the recommendation item into a pre-trained click-through rate prediction model, and outputting the predicted click-through rate of the recommendation item by the click-through rate prediction model.

5. The recommendation method according to claim 1, further comprising:
acquiring user feedback behavior data of a historical recommendation item;
determining a recommendation strategy of the final recommendation item, according to the user feedback behavior data.

6. The recommendation method according to claim 1, wherein the contextual information comprises: at least one of user inquiry information, system prompt information and user interest information.

7. The recommendation method according to claim 4, wherein the click-through rate prediction model is trained by:
determining a current round of training requirement and training contextual information, according to training session information;
determining a plurality of training recommendation items according to the current round of training requirement and the training contextual information; and
acquiring actual click-through rates of the training recommendation items, and training the click-through rate prediction model by taking the training contextual information, features of the training recommendation items and the actual click-through rates of the training recommendation items as training samples.

8. The recommendation method according to claim 7, wherein a feature of each training recommendation item of the training recommendation items comprises at least one of a matching degree between the training recommendation item and the current round of training requirement, an edit distance between the training recommendation item and the current round of training requirement, a consistency between the training recommendation item and an intention of the current round of training requirement, and a presentation position of the training recommendation item.

9. A recommendation apparatus, comprising:
one or more processors; and
a storage device configured to store one or more programs, wherein
the one or more programs, when executed by the one or more processors, cause the one or more processors to:
determine a current round of requirement and contextual information, according to session information;
determine a plurality of recommendation items according to the current round of requirement and the contextual information;
for each recommendation item of the recommendation items, determine a predicted click-through rate of the recommendation item according to the contextual information and a feature of the recommendation item; and
determine at least one final recommendation item from the plurality of recommendation items, according to predicted click-through rates of the recommendation items.

10. The recommendation apparatus according to claim 9, wherein the one or more programs, when executed by the one or more processors, cause the one or more processors further to:
perform a preliminary filtering process on the plurality of recommendation items, to acquire a plurality of recommendation items after the preliminary filtering process, wherein
the one or more programs, when executed by the one or more processors, cause the one or more processors further to:
determine historical access data of the recommendation items and relevancies between the recommendation items and the keyword, and filter out a recommendation item whose historical access data and relevancy do not satisfy a preset condition; and/or
filter out a repetitive recommendation item from the plurality of recommendation items.

11. The recommendation apparatus according to claim 9, wherein the one or more programs, when executed by the one or more processors, cause the one or more processors further to:
extract a contextual feature from the contextual information; and
input the contextual feature and the feature of the recommendation item into a pre-trained click-through rate prediction model, and output the predicted click-through rate of the recommendation item by the click-through rate prediction model.

12. The recommendation apparatus according to claim 9, wherein the one or more programs, when executed by the one or more processors, cause the one or more processors further to:
acquire user feedback behavior data of a historical recommendation item; and
determine a recommendation strategy of the final recommendation item, according to the user feedback behavior data.

13. The recommendation apparatus according to claim 11, wherein the click-through rate prediction model is trained by:
determining a current round of training requirement and training contextual information, according to training session information;
determining a plurality of training recommendation items according to the current round of training requirement and the training contextual information; and
acquiring actual click-through rates of the training recommendation items, and training the click-through rate prediction model by taking the training contextual information, features of the training recommendation items and the actual click-through rates of the training recommendation items as training samples.

14. A non-transitory computer readable storage medium comprising computer executable instructions stored thereon, wherein the executable instructions, when executed by a computer, causes the computer to:
determine a current round of requirement and contextual information, according to session information;
determine a plurality of recommendation items according to the current round of requirement and the contextual information;
for each recommendation item of the recommendation items, determine a predicted click-through rate of the recommendation item according to the contextual information and a feature of the recommendation item; and
determine at least one final recommendation item from the plurality of recommendation items, according to predicted click-through rates of the recommendation items.

15. The non-transitory computer-readable storage medium according to claim 14, wherein the executable instructions, when executed by the computer, causes the computer further to:
extract a user intention and a keyword from the current round of requirement and the contextual information; and
retrieve the plurality of recommendation items from search data, according to the user intention and the keyword.

16. The non-transitory computer-readable storage medium according to claim 15, wherein the executable instructions, when executed by the computer, causes the computer further to:
perform a preliminary filtering process on the plurality of recommendation items, to acquire a plurality of recommendation items after the preliminary filtering process, wherein
the executable instructions, when executed by the computer, causes the computer further to:
determine historical access data of the recommendation items and relevancies between the recommendation items and the keyword, and filter out a recommendation item whose historical access data and relevancy do not satisfy a preset condition; and/or
filter out a repetitive recommendation item from the plurality of recommendation items.

17. The non-transitory computer-readable storage medium according to claim 14, wherein the executable instructions, when executed by the computer, causes the computer further to:
extract a contextual feature from the contextual information; and
input the contextual feature and the feature of the recommendation item into a pre-trained click-through rate prediction model, and output the predicted click-through rate of the recommendation item by the click-through rate prediction model.

18. The non-transitory computer-readable storage medium according to claim 14, wherein the executable instructions, when executed by the computer, causes the computer further to:
acquire user feedback behavior data of a historical recommendation item;
determine a recommendation strategy of the final recommendation item, according to the user feedback behavior data.

19. The non-transitory computer-readable storage medium according to claim 14, wherein the contextual information comprises: at least one of user inquiry information, system prompt information and user interest information.

20. The non-transitory computer-readable storage medium according to claim 17, wherein the click-through rate prediction model is trained by:
determining a current round of training requirement and training contextual information, according to training session information;
determining a plurality of training recommendation items according to the current round of training requirement and the training contextual information; and
acquiring actual click-through rates of the training recommendation items, and training the click-through rate prediction model by taking the training contextual information, features of the training recommendation items and the actual click-through rates of the training recommendation items as training samples.
